(19) United States
(12) Patent Application Publication
(10) Pub. No.: US 2023/0169171 A1
(43) Pub. Date: Jun. 1, 2023

(54) OS-MANAGED BIOS MODULES

(71) Applicant: Intel Corporation, Santa Clara, CA (US)

(72) Inventors: Sarathy Jayakumar, Porland, OR (US); Zijian You, Shanghai (CN)

(21) Appl. No.: 17/996,936

(22) PCT Filed: May 11, 2020
(86) PCT No.: PCT/CN2020/089576

§ 371 Date: Oct. 24, 2022

(51) Int. Cl. G06F 21/57; G06F 21/54

(52) U.S. Cl. CPC G06F 21/572; G06F 21/54; G06F 21/575

(57) ABSTRACT

Systems, apparatuses and methods may provide technology for managing BIOS modules. The technology may include a boot controller to perform a boot procedure by loading and executing a basic input output system (BIOS) boot module, a setup controller to load and execute a BIOS boot module during runtime (i.e., bypassing reboot) using a changed hardware configuration parameter, and an update controller to load and execute a new or updated BIOS boot module during runtime (i.e., bypassing reboot), where each controller is to operate under direction of an operating system (OS). The technology may perform these BIOS operations within a secure BIOS environment.

### TECHNICAL FIELD

Embodiments generally relate to computing systems. More particularly, embodiments relate to managing BIOS modules including BIOS updates and BIOS setup changes.

### BACKGROUND

Computing systems, including servers used in wide variety of activities (such as cloud data centers) rely upon to initialize system hardware components, and to initiate loading of an operating system. BIOS firmware typically is provided in the form of BIOS modules, which are typically stored in a protected device such as a flash drive in the computing system. Changes to a computing system hardware configuration are implemented through a BIOS setup change, in which new (i.e., changed) parameters may be provided for the hardware configuration. Updated or new versions of one or more BIOS modules may be provided, for example to provide security or functional fixes or enhancements.

In existing computer systems, BIOS modules are managed through a BIOS core code, and are outside of the control of the operating system (OS). Thus, implementing BIOS setup changes requires a system reboot. Installation of updated BIOS modules likewise requires a system reboot (there is a limited exception for updating some runtime-only BIOS modules without reboot). However, a system reboot causes the particular computing system (e.g., server) to become effectively non-operational for its ordinary tasking during the reboot process, which may cause a significant loss in availability and productivity, particularly where many such servers or systems may be deployed.

### BRIEF DESCRIPTION OF THE DRAWINGS

The various advantages of the embodiments will become apparent to one skilled in the art by reading the following specification and appended claims, and by referencing the following drawings, in which:

FIGS. 1A-1B provide comparative diagrams illustrating a conventional BIOS and OS boot flow and an improved BIOS and OS boot flow according to one or more embodiments;

FIGS. 2A-2B provide comparative diagrams illustrating a conventional BIOS and OS update / setup change flow and an improved BIOS and OS update / setup change flow according to one or more embodiments;

FIG. 3 provides a diagram illustrating BIOS chain of trust in boot flow according to one or more embodiments;

FIG. 4 provides a diagram illustrating secure BIOS updating according to one or more embodiments;

FIGS. 5A-5B provide diagrams illustrating aspects relating to a secure BIOS environment according to one or more embodiments;

FIG. 6 provides a diagram illustrating components of an improved computing system for managing BIOS modules according to one or more embodiments;

FIG. 7 provides a flowchart illustrating a process for managing BIOS modules according to one or more embodiments;

FIG. 8 provides a block diagram illustrating an example system for managing BIOS modules according to one or more embodiments;

FIG. 9 is a block diagram illustrating an example semiconductor apparatus for managing BIOS modules according to one or more embodiments;

FIG. 10 is a block diagram illustrating an example processor according to one or more embodiments; and

FIG. 11 is a block diagram illustrating an example of a multiprocessor-based computing system according to one or more embodiments.

### DESCRIPTION OF EMBODIMENTS

An improved computing system as described herein may manage BIOS modules via an operating system (OS) running on the computing system. In the improved computing system of this disclosure BIOS modules are accessible to the OS, and accordingly the OS may direct or control execution of all but the most critical BIOS modules. Because the OS may direct or control execution of BIOS modules, BIOS setup changes and BIOS updates for those modules may be accomplished without a system reboot.

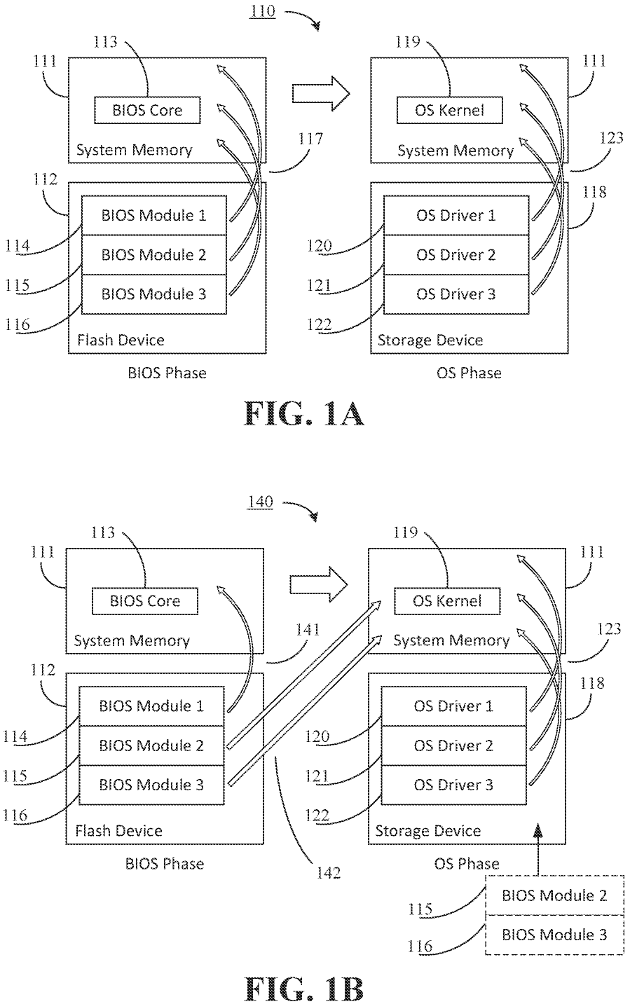

FIG. 1A provides a diagram illustrating a conventional BIOS and operating system (OS) boot flow 110 for a typical computing system. The typical computing system has system memory 111 for executing code, a BIOS flash device 112 that stores BIOS modules, and a storage device 118 that stores operating system code (and other programs). BIOS flash device 112 may serve as startup BIOS memory. At system startup, BIOS Core 113 loads into system memory 111 and proceeds to manage the BIOS boot phase, which includes (at label 117) loading BIOS boot modules 114, 115 and 116 into system memory and executing the modules. This BIOS boot phase establishes the hardware configuration for the computing system, and the hardware configuration is then locked down by the BIOS (via setting certain hardware configuration registers, such as, e.g., registers in the BOOT_W security policy group) such that no changes to the configuration may be implemented without a reboot. Locking down the hardware configuration is intended to prevent inadvertent or malicious changes to the system during OS runtime.

Once the BIOS modules have been loaded and executed, OS Kernel 119 is loaded into system memory 111 (e.g., via initiating an OS loader) and control is passed to the OS via OS Kernel 119. OS Kernel 119 proceeds to manage the OS boot phase, which includes (at label 123) loading OS drivers 120, 121 and 122 into system memory and executing the drivers. BIOS modules are removed from system memory unless designated as runtime BIOS.

FIG. 1B provides a diagram illustrating an improved BIOS and OS boot flow 140 in an improved system for managing BIOS modules according to one or more embodiments, with reference to components and features described herein including but not limited to the figures and associated description. FIG. 1B illustrates many of the same components and aspects as described with reference to FIG. 1A, but with several key changes. In improved BIOS and OS boot flow 140 (and in contrast to conventional boot flow 110), during the initial part of the BIOS boot phase only a limited portion of BIOS boot modules may be loaded into system memory and executed by BIOS Core 113, such as, e.g. (at label 141) loading and executing only BIOS module 114 (which may be a critical BIOS module).

Once BIOS module 114 has been loaded and executed, OS Kernel 119 is loaded into system memory 111 (e.g., via initiating an OS loader) and control is passed to the OS via OS Kernel 119. OS Kernel 119 may proceed to complete the BIOS boot phase (at label 142) by loading and executing the remaining BIOS modules 115 and 116. For this purpose, OS Kernel 119 has at least read access to flash device 112 (or to any device serving as startup BIOS memory). BIOS modules have known interfaces such that the OS may readily access the modules and can pass parameters to the BIOS boot modules while invoking them. In this way, only the most critical BIOS boot module or modules need to be loaded and executed by BIOS Core 113; the remaining BIOS boot modules (such as BIOS modules addressing configurable hardware components) may be loaded and executed by the OS. As described further below, the OS may load and execute BIOS modules in a secure BIOS environment, which may include authenticating any BIOS modules before executing them. By this process, the hardware configuration is set but is not locked down. As a result, the OS will be able at a later time to perform BIOS updates and setup changes while bypassing (i.e., without) a system reboot. Once the BIOS boot phase is completed, OS Kernel 119 then manages the OS boot phase as described herein with reference to FIG. 1A.

With utilization of the improved BIOS and OS boot flow 140, system configuration policy may be centralized and under the control of the OS. Thus, the OS may determine which BIOS modules to load and which hardware configuration parameters to pass to the BIOS modules. As a result, this reduces or eliminates inconsistencies or potential conflicts between BIOS and the OS. In some embodiments, BIOS Core 113 may load and execute only the most critical BIOS module(s) and any BIOS modules necessary to set up a generic hardware configuration, such that the OS may run additional BIOS modules and control the configuration parameters to set the configuration in a more specialized or customized manner. Examples of hardware configuration items that may be managed by the OS may include hardware configuration parameters to set (including enable/disable, establish size or performance levels, etc.) a hardware port; a memory or drive partition; CPU power package limits and flexible ratios; persistent memory (e.g., 3DX point memory) configuration; and/or platform controller hub (PCH) configuration for clock gating, serial peripheral interface (SPI), power management controller (PMC), and/or direct media interface (DMI).

The BIOS boot modules to be managed by the OS (including BIOS modules 115 and/or 116) may be stored in memory other than startup BIOS memory (i.e. BIOS flash device 112 which serves as startup BIOS memory as shown in FIG. 1B). For example, as shown in FIG. 1B, BIOS boot modules 115 and/or 116 may be stored in storage device 118 along with OS components. Alternatively, BIOS modules could be stored in any memory or storage available to the OS. This provides several advantages, including greater flexibility for managing the BIOS modules and in locating new or updated replacement versions (e.g., by locating released versions on the Internet), reduced hardware complexity and cost by requiring lower capacity for the required BIOS flash device. As another advantage, providing for storage of BIOS boot modules in other higher-capacity devices, the BIOS modules themselves may be larger and more robust, providing for more advanced platform and silicon services to the OS.

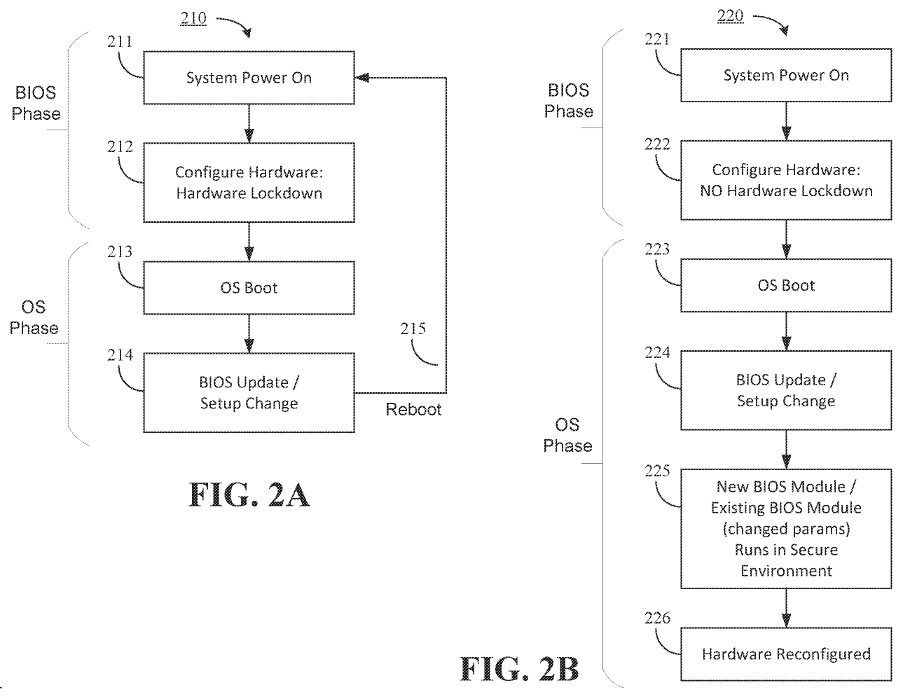

FIG. 2A provides a diagram illustrating a conventional BIOS and OS update / setup change flow 210 for a typical computing system. At block 211, the system powers on and loads BIOS core (e.g., BIOS Core 113) which conducts any power-on testing. At block 212, BIOS modules (such as BIOS boot modules 114, 115 and 116) are loaded and executed, such as described herein with reference to FIG. 1A, to configure the system hardware. Then the hardware configuration is locked down (via setting certain hardware configuration registers). As mentioned herein, locking down the hardware configuration is intended to prevent inadvertent or malicious changes to the system during OS runtime, such as may be caused by malware. Once the hardware configuration is locked down, the BIOS phase is completed.

At block 213, the OS phase begins with OS boot, in which the OS kernel (e.g., OS Kernel 119) is loaded and takes control of loading and executing OS drivers (such as OS drivers 120, 121 and 122) as described herein with reference to FIG. 1A. Once the OS drivers are loaded, normal operation of the computing system under OS control may begin.

At block 214, a BIOS setup change or update request may be presented. Because under conventional system management the OS cannot load and execute BIOS modules, a system reboot (label 215) must occur in order for to implement the desired BIOS setup change or update.

FIG. 2B provides a diagram illustrating an improved BIOS and OS update / setup change flow 220 in an improved system for managing BIOS modules according to one or more embodiments, with reference to components and features described herein including but not limited to the figures and associated description. At block 221, the system powers on and loads BIOS core (e.g., BIOS Core 113) which conducts any power-on testing. At block 222, only critical BIOS module(s) (such as BIOS boot module 114) are loaded and executed by BIOS core, such as described herein with reference to FIGS. 1A and 1B. OS kernel (e.g., OS Kernel 119) is loaded and control passed such that the OS kernel may complete the hardware configuration by loading and executing additional BIOS modules (such as BIOS boot modules 115 and 116), such as described herein with reference to FIGS. 1A and 1B. However, unlike the conventional BIOS and OS update / setup change flow 210, under improved BIOS and OS update / setup change flow 220 the hardware configuration is not locked down.

At block 223, the OS phase begins with OS boot, in which the OS kernel (e.g., OS Kernel 119) loads and executes OS drivers (such as OS drivers 120, 121 and 122) as described herein with reference to FIGS. 1A and 1B. Once the OS drivers are loaded, normal operation of the computing system under OS control may begin.

At block 224, a BIOS setup change or update request may be presented. However, unlike the conventional BIOS and OS update / setup change flow 210, under improved BIOS and OS update / setup change flow 220 a system reboot is not required to implement the desired BIOS setup change or update. Rather, at block 225, the new or updated BIOS module(s) may be loaded and executed, or existing BIOS module(s) may be executed with changed configuration parameters, in each case during runtime under direction of the OS. Loading and executing of new/updated BIOS module(s), or executing BIOS module(s) to implement setup changes, may be performed in a secure BIOS environment (which may include authenticating any BIOS modules before executing them). The OS may direct the new/updated BIOS module(s) and/or new configuration parameters to be stored in the BIOS flash device or other location. New/updated BIOS modules may be provided by the BIOS producer to, e.g., improve system security, improve system functionality (such as via adding features, eliminating or fixing bugs, etc.), and/or provide compatibility with a new or updated hardware device or software package.

BIOS modules (including BIOS boot modules) are typically digitally signed using a private key by the producer of the BIOS module (which may be, e.g., the chipset manufacturer). A BIOS module may be authenticated by obtaining a copy of the public key from the producer of the BIOS module and using the public key to confirm that the BIOS module was signed by the producer. Upon such confirmation, the module may be deemed authenticated.

At block 226, the BIOS update or setup change may be completed, and the hardware reconfigured, during runtime – bypassing system reboot. System operation under OS control may resume or continue.

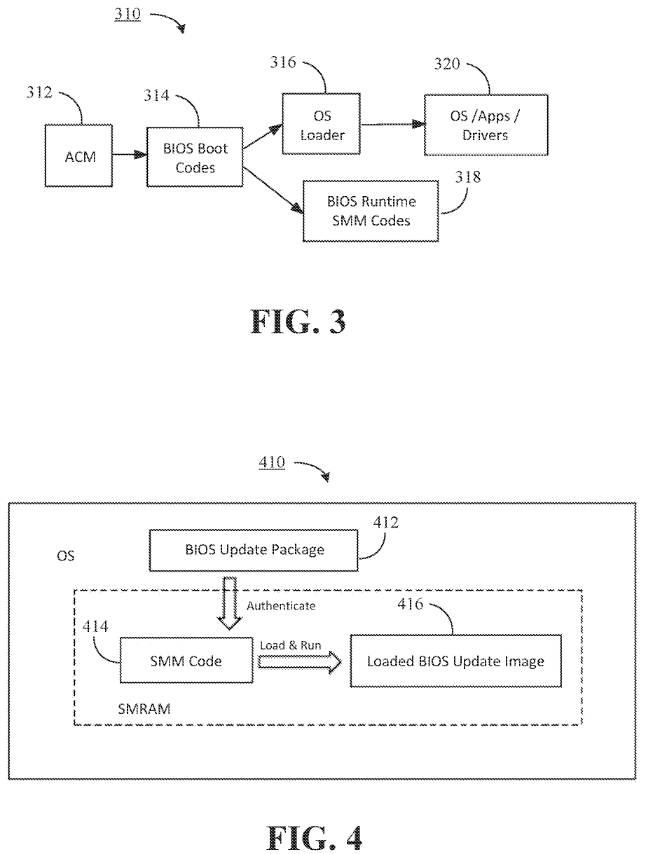

Given security considerations, loading and execution of BIOS modules may be performed within a secure BIOS environment as described herein. Several examples of providing a secure BIOS environment are described below with reference to FIGS. 3, 4 and 5A-5B.

FIG. 3 provides a diagram illustrating a BIOS chain of trust in boot flow 310 according to one or more embodiments, with reference to components and features described herein including but not limited to the figures and associated description. The illustrated BIOS chain of trust establishes a secure environment for OS-directed BIOS execution via invocation of a System Management Mode (SMM) feature available in many processors (CPUs), including microprocessors produced by Intel® and microprocessors produced by at least one other producer. SMM is a special operating mode of a CPU in which normal execution of other software is suspended. SMM may be invoked via a specific interrupt, and once invoked the processor will execute specific SMM code loaded in a separate address space often denoted system management RAM (SMRAM). SMM code is set up at initial startup/boot by BIOS.

As depicted in FIG. 3, Authenticated Code Module (ACM) 312, which is a hardware module authenticated code module that is digitally signed by a chipset manufacturer, passes control to BIOS boot codes 314 (which may include BIOS Core 113) to load and execute one or more BIOS boot modules (e.g., BIOS boot module 114). BIOS core also loads BIOS runtime SMM codes 318 into SMRAM, as well as launching OS loader 316. Each of these transitions is initiated and authenticated by a trusted component; as a result, BIOS runtime SMM codes have the same level of trustworthiness as the BIOS core. OS loader 316 loads the OS kernel (e.g., OS Kernel 119), which then proceeds to direct completion of the BIOS phase and initiate OS phase (including loading of OS drivers and applications 320) as described herein with reference to FIGS. 1A-1B and 2A-2B.

Accordingly, SMM may be utilized to carry out runtime hardware configuration or reconfiguration, under direction of the OS, in a secure manner and providing a secure BIOS environment for executing BIOS boot modules. As part of the secure environment, several security policies are established, such as (1) while not locked down at OS runtime, the hardware can only be reconfigured by SMM software, not by OS software; (2) SMM is not compromised; and (3) SMM authenticates any BIOS boot modules (e.g. updates) loaded at runtime before invoking them.

Policy is met by implementing proper register access rights. Hardware configuration registers can be defined to be only accessible by SMM but not by non-SMM (e.g. OS) code. For example, Intel® implements this policy through SAI (Security Attributes of the Initiator) policy that defines accessibility to hardware resources; this defined policy is enforced at hardware level at system boot, and is not changeable by software. Through SAI, hardware configuration registers are made accessible to SMM, but not to the OS. Policy (2) is met by SMRAM (the memory which SMM code resides in) not being writable by OS level codes, and by various security measures (e.g., page table protection, boundary parameter checking) applied on SMM code. Policy (3) is met by implementing an SMM interface that conducts an authentication of the BIOS module (e.g., an update such as depicted in FIG. 4 below) before executing the module.

The OS may direct SMM to load and execute one or more BIOS modules using the following process. The OS may load the BIOS boot module(s) into system memory, and then invoke SMM via the required interrupt. BIOS SMM code may then copy the BIOS boot module(s) into SMRAM, perform any desired authentication, and execute the BIOS boot module(s) in SMRAM, without system reboot.

To authenticate a BIOS module, SMM may obtain a copy of the public key from the producer of the BIOS module. Using the public key, SMM can confirm that the BIOS module was signed by the producer.

As a further improvement to the secure environment provided via SMM, SMRAM may be made readable (but not writeable) to the OS. In this way, SMRAM becomes a read-only white-box (instead of black-box) to the OS, such that the OS can examine the contents of SMRAM to ensure its integrity. With read access to SMRAM, the OS may perform one or more integrity checks on SMM. For example, the OS may verify that the SMM entry point for the SMM codes is loaded from a well-known robust binary (e.g., built from a trustworthy open source). As another example, the OS may verify the BIOS boot module as loaded in SMRAM by, e.g., conducting an authentication check of the module or by comparing the copy in SMRAM to the copy loaded in system memory (by the OS) to ensure it has not been tampered with.

FIG. 4 provides a diagram illustrating a secure BIOS updating process 410 according to one or more embodiments, with reference to components and features described herein including but not limited to the figures and associated description. As shown in FIG. 4, the OS may receive BIOS update package 412. During runtime the OS may load BIOS update package 412 into system memory and invoke SMM, providing a secure BIOS environment. SMM code 414 authenticates BIOS update package 412, using the authentication process described herein, loads the package in SMRAM, and runs the loaded BIOS update image 416. As such, the desired BIOS update can take effect immediately, without system reboot. A similar secure BIOS setup change process may be carried out to implement a BIOS system change, where during runtime the OS may retrieve a BIOS module (or direct SMM to the BIOS module), provide new or changed configuration parameters, and invoke SMM, which may authenticate the BIOS module, load the BIOS module into SMRAM and execute the BIOS module with the new/changed configuration parameters to implement the desired hardware reconfiguration immediately, without system reboot.

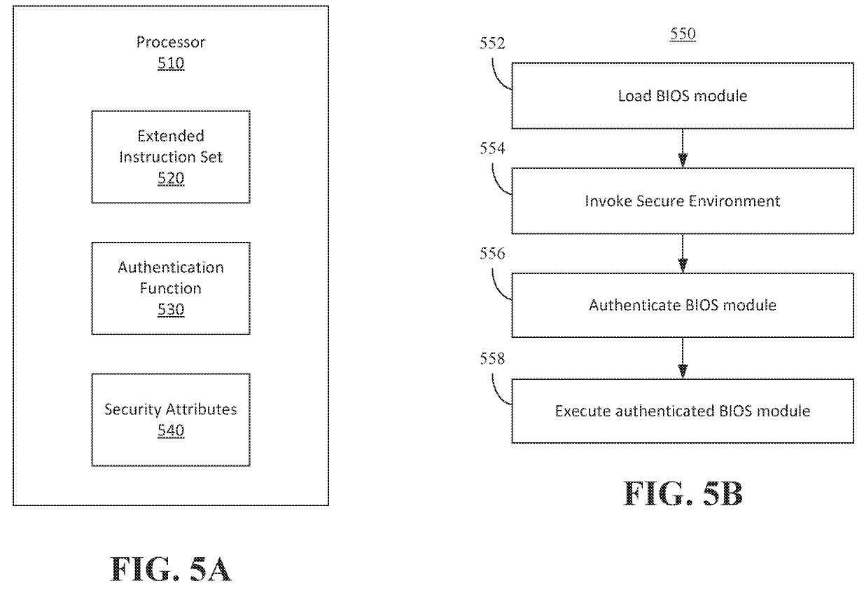

FIGS. 5A-5B provide diagrams illustrating aspects relating to a secure BIOS environment according to one or more embodiments, with reference to components and features described herein including but not limited to the figures and associated description. As shown in FIG. 5A, a processor 510 may have an extended instruction set 520, an authentication function 530, and security attributes 540. Processor 510 may be, for example, a CPU, and may include any type of processing device, such as, e.g., microcontroller, microprocessor, RISC processor, ASIC, etc., along with associated processing modules or circuitry. Processor 510 may include features including SMM, as described herein with reference to FIGS. 3-4.

Extended instruction set 520 may include instructions for carrying out processes for establishing or enforcing a secure environment and/or secure environment policies as described herein, or for supporting or contributing to performance of such processes. As an example, certain Intel® processors include SMX (Safer Mode Extension) which provides an extended set of processor instructions. SMX provides a programming interface for system software to establish a measured environment within a platform to support trust decisions.

Authentication function 530 may provide a mechanism for authenticating BIOS boot modules. As described herein, BIOS modules are typically digitally signed using a private key by the producer of the BIOS module. A BIOS module may be authenticated by obtaining a copy of the public key from the producer of the BIOS module and using the public key to confirm that the BIOS module was signed by the producer. Authentication function 530 may carry out this authentication process in an automated manner. In some embodiments, authentication function 530 may be incorporated within instruction set 520. For example, Intel® SMX instructions include an instruction GETSEC[ENTERACCS] which invokes an authentication function.

Security attributes 540 may include functionality to carry out one or more security policies, such as the security policies described herein with reference to FIG. 3. For example, processor 510 may include functionality implementing hardware configuration register access rights, such that hardware configuration registers can be defined to be only accessible by certain code instructions or during certain processor operating modes. Processor 510 may also include functionality requiring or establishing a secure memory space that can only be written to by certain code instructions or certain processor operating modes, and that is generally not writable by OS level codes. Security attributes may also enforce performance of authentication functions to authenticate a BIOS module before executing the module. In some embodiments, some security attributes may be carried out via instructions in extended instruction set 520 and/or via an operating mode of the processor.

Shown in FIG. 5B is an example process 550 for operating in a secure BIOS environment. Process 550 may be carried out, e.g., by processor 510. At block 552, a secure BIOS environment may be invoked, using, e.g., the functions and procedures described herein. At block 554, a BIOS boot module may be authenticated, using the authentication procedures described herein.. At block 556, the BIOS boot module may be loaded into memory for execution. The memory may have restricted access rights. The BIOS boot module may be loaded as part of an initial startup/boot process, a BIOS update process during runtime, or a BIOS setup change process during runtime. At block 558, the BIOS boot module may be executed, implementing the desired hardware configuration or reconfiguration immediately. Operating under process 550, BIOS updates and/or BIOS setup changes may be implemented during runtime while bypassing a system reboot.

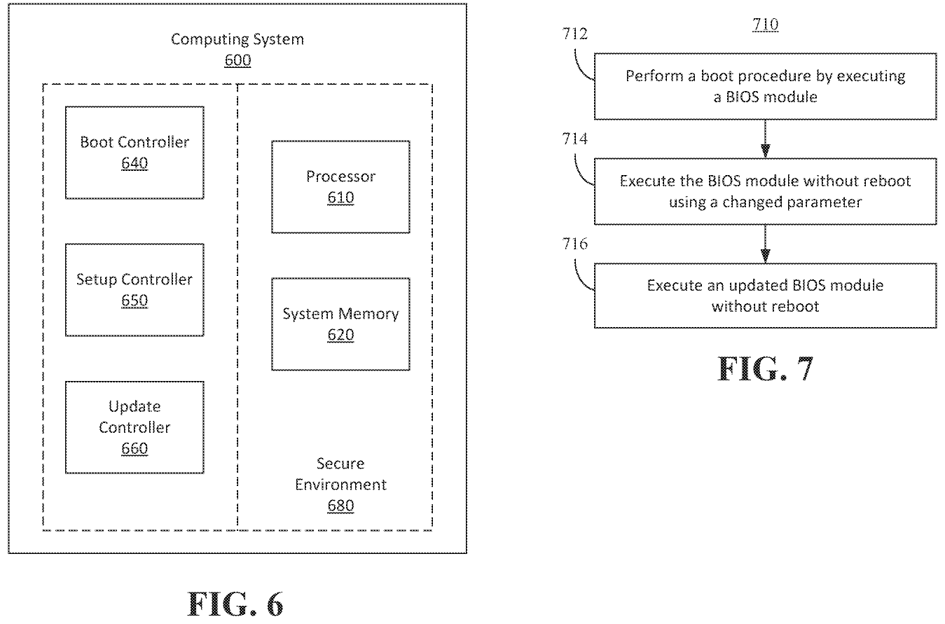

FIG. 6 provides a diagram illustrating components of an improved computing system 600 for managing BIOS modules according to one or more embodiments, with reference to components and features described herein including but not limited to the figures and associated description. Computing system 600 may include logic instructions, configurable logic, fixed-functionality logic hardware, etc., or any combination thereof, and may generally implement one or more aspects of managing BIOS modules as described herein, including improved BIOS and OS boot flow 140, improved BIOS and OS update / setup change flow 220, BIOS chain of trust in boot flow 310, secure BIOS updating process 410, processor 510 and/or process 550 for operating in a secure BIOS environment.

Computing system 600 may include one or more processors 610, system memory 620, boot controller 640, setup controller 650, update controller 660, and may include secure BIOS environment 680. Processor 610 may be, for example, a CPU, and may include any type of processing device, such as, e.g., microcontroller, microprocessor, RISC processor, ASIC, etc., along with associated processing modules or circuitry. Processor 610 may be, e.g., processor 510 described herein with reference to FIG. 5A, or may incorporate some or all features of processor 510. Processor 610 may be communicatively coupled to system memory 620, boot controller 640, setup controller 650 and/or update controller 660.

System memory 620 may include any non-transitory machine- or computer-readable storage medium such as RAM, ROM, PROM, EEPROM, firmware, flash memory, etc., configurable logic such as, for example, PLAs, FPGAs, CPLDs, fixed-functionality hardware logic using circuit technology such as, for example, ASIC, CMOS or TTL technology, or any combination thereof suitable for storing instructions and data. System memory may include, or be accompanied by, memory section(s) or partition(s) that may have restricted access rights, such as, e.g., limited write access such that the memory section(s) or partition(s) provide a secure memory space that can only be written to by certain code instructions or during certain processor operating modes.

Boot controller 640 may be configured to perform procedures for a BIOS boot process to implement some or all aspects of improved BIOS and OS boot flow 140, BIOS chain of trust in boot flow 310, and/or process 550 for operating in a secure BIOS environment, as described herein, and features/functions relating thereto, particularly as to those procedures/features/functions that may relate to a BIOS boot process. As so configured, bios controller 660 may perform a secure BIOS boot process. Boot controller 640 may be communicatively coupled to and may operate in cooperation with other components of computing system 600, including processor 610 and/or system memory 620. Boot controller 640 may include logic instructions, configurable logic, fixed-functionality logic hardware, etc., or any combination thereof. Boot controller 640 may be partially or fully incorporated within the OS, and/or may receive commands or direction from the OS. In some embodiments, aspects of boot controller 640 may be incorporated in or integrated with processor 610, system memory 620, setup controller 650 and/or update controller 660. In some embodiments, initial aspects of a BIOS boot process (such as loading BIOS core and executing a critical BIOS module prior to initiating an OS loader) may be included in procedures performed by boot controller 640; in some embodiments, some or all of these initial aspects of a BIOS boot process may be performed separately.

Setup controller 650 may be configured to perform procedures for a BIOS setup change process to implement some or all aspects of improved BIOS and OS update / setup change flow 220, the secure BIOS setup change process (described herein with reference to FIG. 4), and/or process 550 for operating in a secure BIOS environment, as described herein, and features/functions relating thereto, particularly as to those procedures/features/functions that may relate to a BIOS setup change process. As so configured, setup controller 650 may perform a secure BIOS setup change during runtime without system reboot. Setup controller 650 may be communicatively coupled to and may operate in cooperation with other components of computing system 600, including processor 610 and/or system memory 620. Setup controller 650 may include logic instructions, configurable logic, fixed-functionality logic hardware, etc., or any combination thereof. Setup controller 650 may be partially or fully incorporated within the OS, and/or may receive commands or direction from the OS. In some embodiments, aspects of setup controller 650 may be incorporated in or integrated with processor 610, system memory 620, boot controller 640 and/or update controller 660.

Update controller 660 may be configured to perform procedures for a BIOS update process to implement some or all aspects of improved BIOS and OS update / setup change flow 220, secure BIOS update process 410, and/or process 550 for operating in a secure BIOS environment, as described herein, and features/functions relating thereto, particularly as to those procedures/features/functions that may relate to a BIOS update process. As so configured, update controller 660 may perform a secure BIOS update during runtime while bypassing a system reboot. Update controller 660 may be communicatively coupled to and may operate in cooperation with other components of computing system 600, including processor 610 and/or system memory 620. Update controller 660 may include logic instructions, configurable logic, fixed-functionality logic hardware, etc., or any combination thereof. Update controller 660 may be partially or fully incorporated within the OS, and/or may receive commands or direction from the OS. In some embodiments, aspects of update controller 660 may be incorporated in or integrated with processor 610, system memory 620, boot controller 640 and/or setup controller 650. In some embodiments, update controller 660 may be combined with setup controller 650 to form a combined setup/update controller. In some embodiments, update controller 660 may be combined with boot controller 640 and setup controller 650 to form a combined boot/setup/update controller.

Secure BIOS environment 680 may be established within computing system 600 via operation of, and cooperation between, components including processor 610, system memory 620, boot controller 640, setup controller 650, and/or update controller 660, as described herein. Secure BIOS environment 680 may include some or all of the secure features described herein with reference to FIGS. 3, 4 and 5A-5B. In some embodiments, processor 610 and secure memory 620 may operate within secure BIOS environment 680, once established. In some embodiments, boot controller 640, setup controller 650, and update controller 660 may operate within secure BIOS environment 680. In some embodiments, secure BIOS environment 680 may be established as separate security zones, one zone for processor 610 and secure memory 620 and another zone for boot controller 640, setup controller 650, and update controller 660; each separate security zone may have different parameters, permissions, requirements, etc.

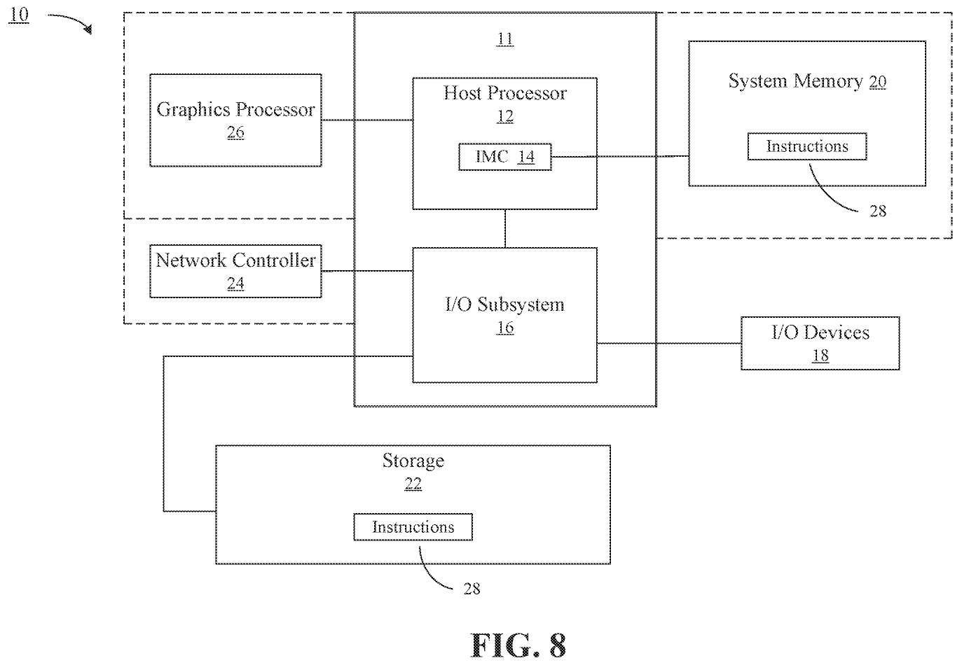

FIG. 7 provides a flowchart illustrating a process 710 for managing BIOS modules according to one or more embodiments, with reference to components and features described herein including but not limited to the figures and associated description. Process 710 may be carried out by computing system 600, described herein with reference to FIG. 6. Process 710 may be performed under direction of an OS on computing system 600.

At block 712, a boot procedure may be performed by loading and executing a BIOS boot module. The boot procedure of block 712 may include some or all of the processes and functionality described herein with reference to FIGS. 1B, 3 and 5B. The boot procedure of block 712 may be performed by boot controller 640, described herein with reference to FIG. 6.

At block 714, a BIOS setup change procedure may be performed by loading and executing a BIOS boot module during runtime, e.g., bypassing reboot (i.e., without reboot), using one or more changed hardware configuration parameters. The setup change procedure of block 714 may include some or all of the processes and functionality described herein with reference to FIGS. 2B, 4 and 5B. The setup change procedure of block 714 may be performed by setup controller 650, described herein with reference to FIG. 6.

At block 716, a BIOS update procedure may be performed by loading and executing a new or updated BIOS boot module during runtime, e.g., bypassing reboot (i.e., without reboot). The update procedure of block 716 may include some or all of the processes and functionality described herein with reference to FIGS. 2B, 4 and 5B. The update procedure of block 716 may be performed by update controller 660, described herein with reference to FIG. 6.

FIG. 8 shows a block diagram illustrating an example computing system 10 for managing BIOS modules according to one or more embodiments, with reference to components and features described herein including but not limited to the figures and associated description. System 10 may generally be part of an electronic device/platform having computing and/or communications functionality (e.g., server, cloud infrastructure controller, database controller, notebook computer, desktop computer, personal digital assistant/PDA, tablet computer, convertible tablet, smart phone, etc.), imaging functionality (e.g., camera, camcorder), media playing functionality (e.g., smart television/TV), wearable functionality (e.g., watch, eyewear, headwear, footwear, jewelry), vehicular functionality (e.g., car, truck, motorcycle), robotic functionality (e.g., autonomous robot), etc., or any combination thereof. In the illustrated example, system 10 may include a host processor 12 (e.g., central processing unit/CPU) having an integrated memory controller (IMC) 14 that may be coupled to system memory 20. Host processor 12 may include any type of processing device, such as, e.g., microcontroller, microprocessor, RISC processor, ASIC, etc., along with associated processing modules or circuitry. System memory 20 may include any non-transitory machine-or computer-readable storage medium such as RAM, ROM, PROM, EEPROM, firmware, flash memory, etc., configurable logic such as, for example, PLAs, FPGAs, CPLDs, fixed-functionality hardware logic using circuit technology such as, for example, ASIC, CMOS or TTL technology, or any combination thereof suitable for storing instructions 28.

System 10 may also include an input/output (I/O) subsystem 16. I/O subsystem 16 may communicate with for example, one or more input/output (I/O) devices 18, a network controller 24 (e.g., wired and/or wireless NIC), and storage 22. Storage 22 may be comprised of any appropriate non-transitory machine- or computer-readable memory type (e.g., flash memory, DRAM, SRAM (static random access memory), solid state drive (SSD), hard disk drive (HDD), optical disk, etc.). Storage 22 may include mass storage. In some embodiments, host processor 12 and/ or I/O subsystem 16 may communicate with storage 22 (all or portions thereof) via network controller 24. In some embodiments, system 10 may also include a graphics processor 26.

Host processor 12 and/or I/O subsystem 16 may execute program instructions 28 retrieved from system memory 20 and/or storage 22 to perform one or more aspects of processes for managing BIOS modules (including BIOS and OS boot flow 140, BIOS and OS update / setup change flow 220, BIOS chain of trust in boot flow 310, secure BIOS updating process 410 and secure BIOS setup change process, process 550 for operating in a secure BIOS environment, boot controller 640, setup controller 650, update controller 660, and/or process 710 for managing BIOS modules) as described herein with reference to FIGS. 1B, 2B, 3, 4, 5A-5B, 6 and 7. System 10 may implement one or more aspects of computing system 600 as described herein with reference to FIG. 6. Host processor 12 may implement one or more aspects of processor 510 and/or processor 610 as described herein with reference to FIGS. 5A and 6.

Host processor 12 and I/O subsystem 16 may be implemented together on a semiconductor die as a system on chip (SoC) 11, shown encased in a solid line. SoC 11 may therefore operate as a computing apparatus for managing BIOS modules. In some embodiments, SoC 11 may also include one or more of system memory 20, network controller 24, and/or graphics processor 26 (shown encased in dotted lines).

Computer program code to carry out the processes described above may be written in any combination of one or more programming languages, including an object-oriented programming language such as JAVA, JAVASCRIPT, PYTHON, SMALLTALK, C++ or the like and/or conventional procedural programming languages, such as the “C” programming language or similar programming languages, and implemented as program instructions 28. Additionally, program instructions 28 may include assembler instructions, instruction set architecture (ISA) instructions, machine instructions, machine dependent instructions, microcode, state-setting data, configuration data for integrated circuitry, state information that personalizes electronic circuitry and/or other structural components that are native to hardware (e.g., host processor, central processing unit/CPU, microcontroller, microprocessor, etc.).

I/O devices 18 may include one or more of input devices, such as a touch-screen, keyboard, mouse, cursor-control device, touch-screen, microphone, digital camera, video recorder, camcorder, biometric scanners and/or sensors; input devices may be used to enter information and interact with system 10 and/or with other devices. I/O devices 18 may also include one or more of output devices, such as a display (e.g., touch screen, liquid crystal display/LCD, light emitting diode/LED display, plasma panels, etc.), speakers and/or other visual or audio output devices. Input and/or output devices may be used, e.g., to provide a user interface.

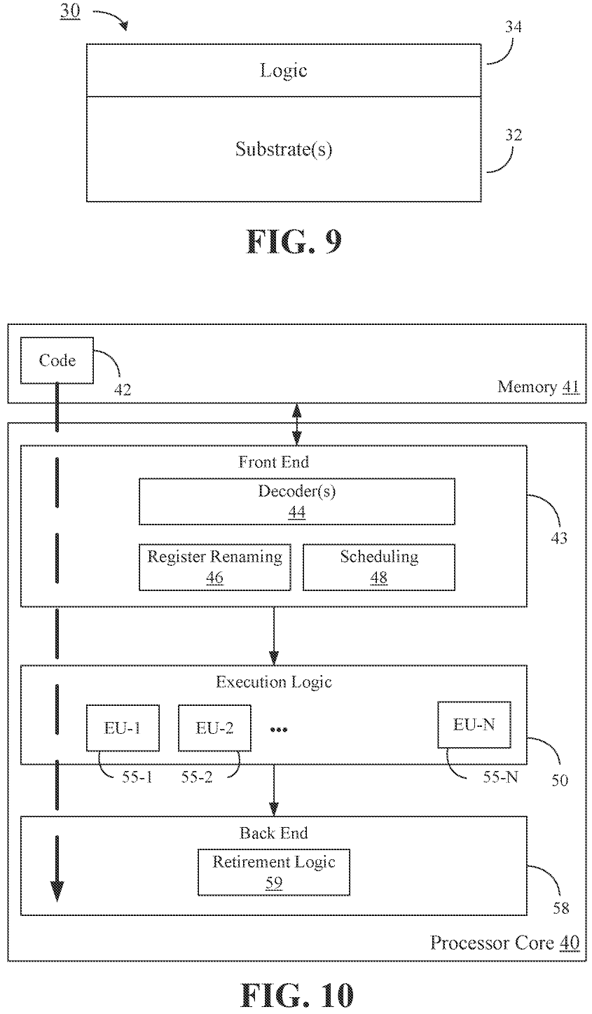

FIG. 9 shows a block diagram illustrating an example semiconductor apparatus 30 for managing BIOS modules according to one or more embodiments, with reference to components and features described herein including but not limited to the figures and associated description. Semiconductor apparatus 30 may be implemented, e.g., as a chip, die, or other semiconductor package. Semiconductor apparatus 30 may include one or more substrates 32 comprised of, e.g., silicon, sapphire, gallium arsenide, etc. Semiconductor apparatus 30 may also include logic 34 comprised of, e.g., transistor array(s) and other integrated circuit (IC) components) coupled to the substrate(s) 32. Logic 34 may implement system on chip (SoC) 11 described above with reference to FIG. 8. Logic 34 may implement one or more aspects of the processes described above, including processes for managing BIOS modules (including BIOS and OS boot flow 140, BIOS and OS update / setup change flow 220, BIOS chain of trust in boot flow 310, secure BIOS updating process 410 and secure BIOS setup change process, process 550 for operating in a secure BIOS environment, boot controller 640, setup controller 650, update controller 660, and/or process 710 for managing BIOS modules) as described herein with reference to FIGS. 1B, 2B, 3, 4, 5A-5B, 6 and 7.

Semiconductor apparatus 30 may be constructed using any appropriate semiconductor manufacturing processes or techniques. Logic 34 may be implemented at least partly in configurable logic or fixed-functionality hardware logic. For example, logic 34 may include transistor channel regions that are positioned (e.g., embedded) within substrate(s) 32. Thus, the interface between logic 34 and substrate(s) 32 may not be an abrupt junction. Logic 34 may also be considered to include an epitaxial layer that is grown on an initial wafer of substrate(s) 34.

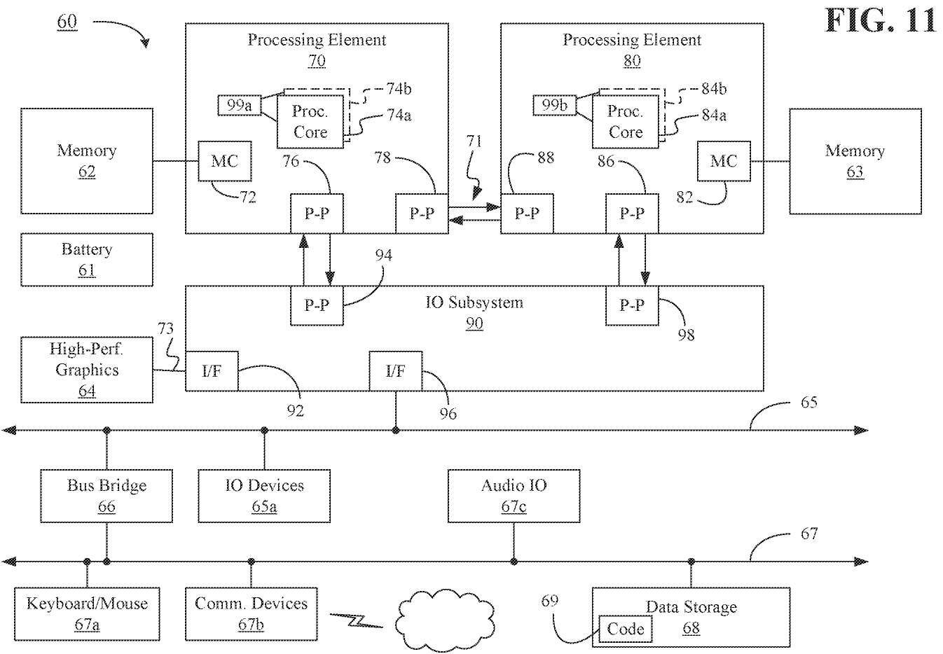

FIG. 10 is a block diagram illustrating an example processor core 40 according to one or more embodiments, with reference to components and features described herein including but not limited to the figures and associated description. Processor core 40 may be the core for any type of processor, such as a micro-processor, an embedded processor, a digital signal processor (DSP), a network processor, or other device to execute code. Although only one processor core 40 is illustrated in FIG. 10, a processing element may alternatively include more than one of the processor core 40 illustrated in FIG. 10. Processor core 40 may be a single-threaded core or, for at least one embodiment, processor core 40 may be multithreaded in that it may include more than one hardware thread context (or “logical processor”) per core.

FIG. 10 also illustrates a memory 41 coupled to processor core 40. Memory 41 may be any of a wide variety of memories (including various layers of memory hierarchy) as are known or otherwise available to those of skill in the art. Memory 41 may include one or more code 42 instruction(s) to be executed by processor core 40. Code 42 may implement one or more aspects of the processes described above, including processes for managing BIOS modules (including BIOS and OS boot flow 140, BIOS and OS update / setup change flow 220, BIOS chain of trust in boot flow 310, secure BIOS updating process 410 and secure BIOS setup change process, process 550 for operating in a secure BIOS environment, boot controller 640, setup controller 650, update controller 660, and/or process 710 for managing BIOS modules) as described herein with reference to FIGS. 1B, 2B, 3, 4, 5A-5B, 6 and 7. Processor core 40 may implement one or more aspects of processor 510 and/or processor 610 as described herein with reference to FIGS. 5A and 6. Processor core 40 follows a program sequence of instructions indicated by code 42. Each instruction may enter a front end portion 43 and be processed by one or more decoders 44. Decoder 44 may generate as its output a micro operation such as a fixed width micro operation in a predefined format, or may generate other instructions, microinstructions, or control signals which reflect the original code instruction. The illustrated front end portion 43 also includes register renaming logic 46 and scheduling logic 48, which generally allocate resources and queue the operation corresponding to the convert instruction for execution.

Processor core 40 is shown including execution logic 50 having a set of execution units 55-1 through 55-N. Some embodiments may include a number of execution units dedicated to specific functions or sets of functions. Other embodiments may include only one execution unit or one execution unit that can perform a particular function. The illustrated execution logic 50 performs the operations specified by code instructions.

After completion of execution of the operations specified by the code instructions, back end logic 58 retires the instructions of code 42. In one embodiment, the processor core 40 allows out of order execution but requires in order retirement of instructions. Retirement logic 59 may take a variety of forms as known to those of skill in the art (e.g., re-order buffers or the like). In this manner, processor core 40 is transformed during execution of code 42, at least in terms of the output generated by the decoder, the hardware registers and tables utilized by the register renaming logic 46, and any registers (not shown) modified by the execution logic 50.

Although not illustrated in FIG. 10, a processing element may include other elements on chip with processor core 40. For example, a processing element may include memory control logic along with processor core 40. The processing element may include I/O control logic and/or may include I/O control logic integrated with memory control logic. The processing element may also include one or more caches.

FIG. 11 is a block diagram illustrating an example of a multi-processor based computing system 60 according to one or more embodiments, with reference to components and features described herein including but not limited to the figures and associated description. Multiprocessor system 60 includes a first processing element 70 and a second processing element 80. While two processing elements 70 and 80 are shown, it is to be understood that an embodiment of the system 60 may also include only one such processing element.

The system 60 is illustrated as a point-to-point interconnect system, wherein the first processing element 70 and the second processing element 80 are coupled via a point-to-point interconnect 71. It should be understood that any or all of the interconnects illustrated in FIG. 11 may be implemented as a multi-drop bus rather than point-to-point interconnect.

As shown in FIG. 11, each of processing elements 70 and 80 may be multicore processors, including first and second processor cores (i.e., processor cores 74a and 74b and processor cores 84a and 84b). Such cores 74a, 74b, 84a, 84b may be configured to execute instruction code in a manner similar to that discussed above in connection with FIG. 10.

Each processing element 70, 80 may include at least one shared cache 99a, 99b. The shared cache 99a, 99b may store data (e.g., instructions) that are utilized by one or more components of the processor, such as the cores 74a, 74b and 84a, 84b, respectively. For example, the shared cache 99a, 99b may locally cache data stored in a memory 62, 63 for faster access by components of the processor. In one or more embodiments, the shared cache 99a, 99b may include one or more mid-level caches, such as level 2 (L2), level 3 (L3), level 4 (L4), or other levels of cache, a last level cache (LLC), and/or combinations thereof.

While shown with only two processing elements 70, 80, it is to be understood that the scope of the embodiments are not so limited. In other embodiments, one or more additional processing elements may be present in a given processor. Alternatively, one or more of processing elements 70, 80 may be an element other than a processor, such as an accelerator or a field programmable gate array. For example, additional processing element(s) may include additional processors(s) that are the same as a first processor 70, additional processor(s) that are heterogeneous or asymmetric to processor a first processor 70, accelerators (such as, e.g., graphics accelerators or digital signal processing (DSP) units), field programmable gate arrays, or any other processing element. There can be a variety of differences between the processing elements 70, 80 in terms of a spectrum of metrics of merit including architectural, micro architectural, thermal, power consumption characteristics, and the like. These differences may effectively manifest themselves as asymmetry and heterogeneity amongst the processing elements 70, 80. For at least one embodiment, the various processing elements 70, 80 may reside in the same die package.

The first processing element 70 may further include memory controller logic (MC) 72 and point-to-point (P-P) interfaces 76 and 78. Similarly, the second processing element 80 may include a MC 82 and P-P interfaces 86 and 88. As shown in FIG. 11, MC’s 72 and 82 couple the processors to respective memories, namely a memory 62 and a memory 63, which may be portions of main memory locally attached to the respective processors. While the MC 72 and 82 is illustrated as integrated into the processing elements 70, 80, for alternative embodiments the MC logic may be discrete logic outside the processing elements 70, 80 rather than integrated therein.

The first processing element 70 and the second processing element 80 may be coupled to an I/O subsystem 90 via P-P interconnects 76 and 86, respectively. As shown in FIG. 11, the I/O subsystem 90 includes P-P interfaces 94 and 98. Furthermore, I/O subsystem 90 includes an interface 92 to couple I/O subsystem 90 with a high performance graphics engine 64. In one embodiment, bus 73 may be used to couple the graphics engine 64 to the I/O subsystem 90. Alternately, a point-to-point interconnect may couple these components.

In turn, I/O subsystem 90 may be coupled to a first bus 65 via an interface 96. In one embodiment, the first bus 65 may be a Peripheral Component Interconnect (PCI) bus, or a bus such as a PCI Express bus or another third generation I/O interconnect bus, although the scope of the embodiments are not so limited.

As shown in FIG. 11, various I/O devices 65a (e.g., biometric scanners, speakers, cameras, sensors) may be coupled to the first bus 65, along with a bus bridge 66 which may couple the first bus 65 to a second bus 67. In one embodiment, the second bus 67 may be a low pin count (LPC) bus. Various devices may be coupled to the second bus 67 including, for example, a keyboard/mouse 67a, communication device(s) 67b, and a data storage unit 68 such as a disk drive or other mass storage device which may include code 69, in one embodiment. The illustrated code 69 may implement one or more aspects of the processes described above, including processes for managing BIOS modules (including BIOS and OS boot flow 140, BIOS and OS update / setup change flow 220, BIOS chain of trust in boot flow 310, secure BIOS updating process 410 and secure BIOS setup change process, process 550 for operating in a secure BIOS environment, boot controller 640, setup controller 650, update controller 660, and/or process 710 for managing BIOS modules) as described herein with reference to FIGS. 1B, 2B, 3, 4, 5A-5B, 6 and 7. The illustrated code 69 may be similar to code 42 (FIG. 10), already discussed. Further, an audio I/O 67c may be coupled to second bus 67 and a battery 61 may supply power to the computing system 60. System 60 may implement one or more aspects of computing system 600 as described herein with reference to FIG. 6. Processing elements 70 and/or 80 may implement one or more aspects of processor 510 and/or processor 610 as described herein with reference to FIGS. 5A and 6.

Note that other embodiments are contemplated. For example, instead of the point-to-point architecture of FIG. 11, a system may implement a multi-drop bus or another such communication topology. Also, the elements of FIG. 11 may alternatively be partitioned using more or fewer integrated chips than shown in FIG. 11.

Embodiments of each of the above systems, devices, components and/or methods, including system 10, semiconductor apparatus 30, processor core 40, system 60, improved BIOS and OS boot flow 140, improved BIOS and OS update / setup change flow 220, BIOS chain of trust in boot flow 310, secure BIOS updating process 410, processor 510, process 550, computing system 600, process 710, and/or any other system components, may be implemented in hardware, software, or any suitable combination thereof. For example, hardware implementations may include configurable logic such as, for example, programmable logic arrays (PLAs), field programmable gate arrays (FPGAs), complex programmable logic devices (CPLDs), or fixed-functionality logic hardware using circuit technology such as, for example, application specific integrated circuit (ASIC), complementary metal oxide semiconductor (CMOS) or transistor-transistor logic (TTL) technology, or any combination thereof.

Alternatively, or additionally, all or portions of the foregoing systems and/or components and/or methods may be implemented in one or more modules as a set of logic instructions stored in a machine- or computer-readable storage medium such as random access memory (RAM), read only memory (ROM), programmable ROM (PROM), firmware, flash memory, etc., to be executed by a processor or computing device. For example, computer program code to carry out the operations of the components may be written in any combination of one or more operating system (OS) applicable/appropriate programming languages, including an object-oriented programming language such as PYTHON, PERL, JAVA, SMALLTALK, C++, C# or the like and conventional procedural programming languages, such as the “C” programming language or similar programming languages.

Each of the systems and methods described above, and each of the embodiments (including implementations) thereof, for managing BIOS modules may be considered performance-enhancing, at least to the extent that the systems and processes, as described herein, provide for the ability to implement BIOS setup changes and BIOS updates without a system reboot, and also permit system configuration policy to be centralized and under the control of the OS, and also provide for the ability to store BIOS boot modules to be managed by the OS in any memory available to the OS, rather than just in a BIOS flash device. Advantages of the technology described herein include increased efficiency and performance by virtue of avoiding system reboots, reduction or elimination of inconsistencies or potential conflicts between BIOS and the OS, improved ability to set hardware configuration in a more specialized or customized manner, greater flexibility in managing the BIOS modules and in locating new or replacement versions, reduction in hardware complexity and cost by requiring lower capacity for a required BIOS flash device, and improved ability to utilize larger and more robust BIOS modules to provide for more advanced platform and silicon services to the OS.

### Additional Notes and Examples

Example 1 includes a computing system comprising a processor, and logic coupled to the processor, the logic comprising a boot controller to perform a boot procedure by loading and executing one or more basic input output system (BIOS) boot modules, a setup controller to load and execute one of the one or more BIOS boot modules during runtime using a changed hardware configuration parameter; and an update controller to load and execute a new or updated BIOS boot module during runtime, wherein each of the boot controller, the setup controller and the update controller is to operate under direction of an operating system (OS) on the computing system.

Example 2 includes the computing system of Example 1, wherein the logic is to establish a secure BIOS environment for execution of the one or more BIOS boot modules and execution of the new or updated BIOS boot module.

Example 3 includes the computing system of Example 2, wherein to establish the secure BIOS environment the logic is to include authenticating each of the one or more BIOS boot modules and the new or updated BIOS boot module prior to execution.

Example 4 includes the computing system of Example 3, wherein to establish the secure BIOS environment the logic is further to include at least one of limiting access rights to a hardware configuration register or limiting access rights to a memory from which each of the one or more BIOS boot modules and the new or updated BIOS boot module is to be executed.

Example 5 includes the computing system of Example 4, wherein the secure BIOS environment is provided at least in part by an extended instruction set or an operating mode of the processor to support boot module authentication, limited hardware register access rights, or limited memory access rights.

Example 6 includes the computing system of Example 1, wherein the changed hardware configuration parameter includes one of a parameter to set a hardware port, a memory or drive partition, a CPU power package limit or flexible ratio, a persistent memory configuration, or a platform controller hub (PCH) configuration for clock gating, serial peripheral interface (SPI), power management controller (PMC), and/or direct media interface (DMI), and wherein the new or updated bios boot module is to at least one of improve system security, improve system functionality, and/or provide compatibility with a new or updated hardware device or software package.

Example 7 includes the computing system of any of Examples 1-6, wherein the one or more BIOS boot modules are to be retrieved from memory other than startup BIOS memory prior to execution.

Example 8 includes a semiconductor apparatus comprising one or more substrates, and logic coupled to the one or more substrates, wherein the logic is implemented at least partly in one or more of configurable logic or fixed-functionality hardware logic, the logic coupled to the one or more substrates to perform a boot procedure by loading and executing one or more basic input output system (BIOS) boot modules, load and execute one of the one or more BIOS boot modules during runtime using a changed hardware configuration parameter, and load and execute a new or updated BIOS boot module during runtime, wherein the logic is to operate under direction of an operating system (OS) on a computing system.

Example 9 includes the apparatus of Example 8, wherein the logic is further to establish a secure BIOS environment for execution of the one or more BIOS boot modules and execution of the new or updated BIOS boot module.

Example 10 includes the apparatus of Example 9, wherein to establish the secure BIOS environment the logic is to include authenticating each of the one or more BIOS boot modules and the new or updated BIOS boot module prior to execution.

Example 11 includes the apparatus of Example 10, wherein to establish the secure BIOS environment the logic is further to include at least one of limiting access rights to a hardware configuration register or limiting access rights to a memory from which each of the one or more BIOS boot modules and the new or updated BIOS boot module is to be executed.

Example 12 includes the apparatus of Example 11, wherein the secure BIOS environment is provided at least in part by an extended instruction set or an operating mode of the processor to support boot module authentication, limited hardware register access rights, or limited memory access rights.

Example 13 includes the apparatus of Example 8, wherein the changed hardware configuration parameter includes one of a parameter to set a hardware port, a memory or drive partition, a CPU power package limit or flexible ratio, a persistent memory configuration, or a platform controller hub (PCH) configuration for clock gating, serial peripheral interface (SPI), power management controller (PMC), and/or direct media interface (DMI), and wherein the new or updated bios boot module is to at least one of improve system security, improve system functionality, and/or provide compatibility with anew or updated hardware device or software package.

Example 14 includes the apparatus of Example 8, wherein the one or more BIOS boot modules are to be retrieved from memory other than startup BIOS memory prior to execution.

Example 15 includes the apparatus of any of Examples 8-14, wherein the logic coupled to the one or more substrates includes transistor channel regions that are positioned within the one or more substrates.

Example 16 includes a method of managing BIOS modules comprising performing, under direction of an operating system (OS), a boot procedure by loading and executing one or more basic input output system (BIOS) boot modules, loading and executing, under direction of the OS, one of the one or more BIOS boot modules during runtime using a changed hardware configuration parameter, and loading and executing, under direction of the OS, a new or updated BIOS boot module during runtime, wherein the OS is executing on a computing system.

Example 17 includes the method of Example 16, further comprising establishing a secure BIOS environment for execution of the one or more BIOS boot modules and execution of the new or updated BIOS boot module.

Example 18 includes the method of Example 17, wherein establishing the secure BIOS environment includes authenticating each of the one or more BIOS boot modules and the new or updated BIOS boot module prior to execution, and at least one of limiting access rights to a hardware configuration register or limiting access rights to a memory from which each of the one or more BIOS boot modules and the new or updated BIOS boot module is to be executed, and wherein the secure BIOS environment is provided at least in part by an extended instruction set or an operating mode of the processor to support boot module authentication, limited hardware register access rights, or limited memory access rights.

Example 19 includes the method of any of Examples 16-18, wherein the one or more BIOS boot modules are to be retrieved from memory other than startup BIOS memory prior to execution.

Example 20 includes at least one non-transitory computer readable storage medium comprising a set of instructions which, when executed by a computing system, cause the computing system to perform, under direction of an operating system (OS), a boot procedure by loading and executing one or more basic input output system (BIOS) boot modules, load and execute, under direction of the OS, one of the one or more BIOS boot modules during runtime using a changed hardware configuration parameter, and load and execute, under direction of the OS, a new or updated BIOS boot module during runtime, wherein the OS is to execute on the computing system.

Example 21 includes the at least one non-transitory computer readable storage medium of Example 20, wherein the instructions, when executed by a computing system, further cause the computing system to establish a secure BIOS environment for execution of the one or more BIOS boot modules and execution of the new or updated BIOS boot module.

Example 22 includes the at least one non-transitory computer readable storage medium of Example 21, wherein to establish the secure BIOS environment, the instructions, when executed by the computing system, cause the computing system to authenticate each of the one or more BIOS boot modules and the new or updated BIOS boot module prior to execution, and at least one of limit access rights to a hardware configuration register or limit access rights to a memory from which each of the one or more BIOS boot modules and the new or updated BIOS boot module is to be executed.

Example 23 includes the at least one non-transitory computer readable storage medium of Example 22, wherein the secure BIOS environment is provided at least in part by an extended instruction set or an operating mode of the processor to support boot module authentication, limited hardware register access rights, or limited memory access rights.

Example 24 includes the at least one non-transitory computer readable storage medium of Example 20, wherein the changed hardware configuration parameter includes one of a parameter to set a hardware port, a memory or drive partition, a CPU power package limit or flexible ratio, a persistent memory configuration, or a platform controller hub (PCH) configuration for clock gating, serial peripheral interface (SPI), power management controller (PMC), and/or direct media interface (DMI), and wherein the new or updated bios boot module is to at least one of improve system security, improve system functionality, and/or provide compatibility with a new or updated hardware device or software package.

Example 25 includes the at least one non-transitory computer readable storage medium of any of Examples 20-24, wherein the one or more BIOS boot modules are to be retrieved from memory other than startup BIOS memory prior to execution.

Example 26 includes an apparatus comprising means for performing the method of any one of Examples 16-18.

Thus, technology described herein improves the performance of computing systems through managing BIOS modules, allowing execution of BIOS modules with new or changed parameters to implement setup changes while bypassing reboot (i.e., without reboot), and execution of updated BIOS modules to implement updates while bypassing reboot. The technology may perform execution of BIOS modules in a secure BIOS environment. The technology described herein may be applicable in any number of computing environments, including servers, cloud computing, and/or any environment providing computing services where productivity or quality of service (QoS) is an important or critical consideration.

Embodiments are applicable for use with all types of semiconductor integrated circuit (“IC”) chips. Examples of these IC chips include but are not limited to processors, controllers, chipset components, programmable logic arrays (PLAs), memory chips, network chips, systems on chip (SoCs), SSD/NAND controller ASICs, and the like. In addition, in some of the drawings, signal conductor lines are represented with lines. Some may be different, to indicate more constituent signal paths, have a number label, to indicate a number of constituent signal paths, and/or have arrows at one or more ends, to indicate primary information flow direction. This, however, should not be construed in a limiting manner. Rather, such added detail may be used in connection with one or more exemplary embodiments to facilitate easier understanding of a circuit. Any represented signal lines, whether or not having additional information, may actually comprise one or more signals that may travel in multiple directions and may be implemented with any suitable type of signal scheme, e.g., digital or analog lines implemented with differential pairs, optical fiber lines, and/or single-ended lines.

Example sizes/models/values/ranges may have been given, although embodiments are not limited to the same. As manufacturing techniques (e.g., photolithography) mature over time, it is expected that devices of smaller size could be manufactured. In addition, well known power/ground connections to IC chips and other components may or may not be shown within the figures, for simplicity of illustration and discussion, and so as not to obscure certain aspects of the embodiments. Further, arrangements may be shown in block diagram form in order to avoid obscuring embodiments, and also in view of the fact that specifics with respect to implementation of such block diagram arrangements are highly dependent upon the platform within which the embodiment is to be implemented, i.e., such specifics should be well within purview of one skilled in the art. Where specific details (e.g., circuits) are set forth in order to describe example embodiments, it should be apparent to one skilled in the art that embodiments can be practiced without, or with variation of, these specific details. The description is thus to be regarded as illustrative instead of limiting.

The term “coupled” may be used herein to refer to any type of relationship, direct or indirect, between the components in question, and may apply to electrical, mechanical, fluid, optical, electromagnetic, electromechanical or other connections. In addition, the terms “first”, “second”, etc. may be used herein only to facilitate discussion, and carry no particular temporal or chronological significance unless otherwise indicated.

As used in this application and in the claims, a list of items joined by the term “one or more of” may mean any combination of the listed terms. For example, the phrases “one or more of A, B or C” may mean A, B, C; A and B; A and C; B and C; or A, B and C.

Those skilled in the art will appreciate from the foregoing description that the broad techniques of the embodiments can be implemented in a variety of forms. Therefore, while the embodiments have been described in connection with particular examples thereof, the true scope of the embodiments should not be so limited since other modifications will become apparent to the skilled practitioner upon a study of the drawings, specification, and following claims.

1-25. (canceled)

26. A computing system, comprising:
a processor; and
logic coupled to the processor, the logic comprising:
a boot controller to perform a boot procedure by loading and executing one or more basic input output system (BIOS) boot modules;
a setup controller to load and execute one of the one or more BIOS boot modules during runtime using a changed hardware configuration parameter; and
an update controller to load and execute a new or updated BIOS boot module during runtime;
wherein each of the boot controller, the setup controller and the update controller is to operate under direction of an operating system (OS) on the computing system.

27. The computing system of claim 26, wherein the logic is to establish a secure BIOS environment for execution of the one or more BIOS boot modules and execution of the new or updated BIOS boot module.

28. The computing system of claim 27, wherein to establish the secure BIOS environment the logic is to include authenticating each of the one or more BIOS boot modules and the new or updated BIOS boot module prior to execution.

29. The computing system of claim 28, wherein to establish the secure BIOS environment the logic is further to include at least one of limiting access rights to a hardware configuration register or limiting access rights to a memory from which each of the one or more BIOS boot modules and the new or updated BIOS boot module is to be executed.

30. The computing system of claim 29, wherein the secure BIOS environment is provided at least in part by an extended instruction set or an operating mode of the processor to support boot module authentication, limited hardware register access rights, or limited memory access rights.

31. The computing system of claim 26, wherein the changed hardware configuration parameter includes one of a parameter to set a hardware port, a memory or drive partition, a CPU power package limit or flexible ratio, a persistent memory configuration, or a platform controller hub (PCH) configuration for clock gating, serial peripheral interface (SPI), power management controller (PMC), and/or direct media interface (DMI), and
wherein the new or updated bios boot module is to at least one of improve system security, improve system functionality, and/or provide compatibility with a new or updated hardware device or software package.

32. The computing system of claim 26, wherein the one or more BIOS boot modules are to be retrieved from memory other than startup BIOS memory prior to execution.

33. A semiconductor apparatus comprising:
one or more substrates; and
logic coupled to the one or more substrates, wherein the logic is implemented at least partly in one or more of configurable logic or fixed-functionality hardware logic, the logic coupled to the one or more substrates to:
perform a boot procedure by loading and executing one or more basic input output system (BIOS) boot modules;
load and execute one of the one or more BIOS boot modules during runtime using a changed hardware configuration parameter; and
load and execute a new or updated BIOS boot module during runtime;
wherein the logic is to operate under direction of an operating system (OS) on a computing system.

34. The apparatus of claim 33, wherein the logic is further to establish a secure BIOS environment for execution of the one or more BIOS boot modules and execution of the new or updated BIOS boot module.

35. The apparatus of claim 34, wherein to establish the secure BIOS environment the logic is to include authenticating each of the one or more BIOS boot modules and the new or updated BIOS boot module prior to execution.

36. The apparatus of claim 35, wherein to establish the secure BIOS environment the logic is further to include at least one of limiting access rights to a hardware configuration register or limiting access rights to a memory from which each of the one or more BIOS boot modules and the new or updated BIOS boot module is to be executed.

37. The apparatus of claim 36, wherein the secure BIOS environment is provided at least in part by an extended instruction set or an operating mode of the processor to support boot module authentication, limited hardware register access rights, or limited memory access rights.

38. The apparatus of claim 33, wherein the changed hardware configuration parameter includes one of a parameter to set a hardware port, a memory or drive partition, a CPU power package limit or flexible ratio, a persistent memory configuration, or a platform controller hub (PCH) configuration for clock gating, serial peripheral interface (SPI), power management controller (PMC), and/or direct media interface (DMI), and
wherein the new or updated bios boot module is to at least one of improve system security, improve system functionality, and/or provide compatibility with a new or updated hardware device or software package.

39. The apparatus of claim 33, wherein the one or more BIOS boot modules are to be retrieved from memory other than startup BIOS memory prior to execution.

40. The apparatus of claim 33, wherein the logic coupled to the one or more substrates includes transistor channel regions that are positioned within the one or more substrates.

41. A method of managing BIOS modules comprising:
performing, under direction of an operating system (OS), a boot procedure by loading and executing one or more basic input output system (BIOS) boot modules;
loading and executing, under direction of the OS, one of the one or more BIOS boot modules during runtime using a changed hardware configuration parameter; and
loading and executing, under direction of the OS, a new or updated BIOS boot module during runtime;
wherein the OS is executing on a computing system.

42. The method of claim 41, further comprising establishing a secure BIOS environment for execution of the one or more BIOS boot modules and execution of the new or updated BIOS boot module.

43. The method of claim 42, wherein establishing the secure BIOS environment includes:
authenticating each of the one or more BIOS boot modules and the new or updated BIOS boot module prior to execution; and
at least one of limiting access rights to a hardware configuration register or limiting access rights to a memory from which each of the one or more BIOS boot modules and the new or updated BIOS boot module is to be executed; and
wherein the secure BIOS environment is provided at least in part by an extended instruction set or an operating mode of the processor to support boot module authentication, limited hardware register access rights, or limited memory access rights.

44. The method of claim 41, wherein the one or more BIOS boot modules are to be retrieved from memory other than startup BIOS memory prior to execution.

45. At least one computer readable storage medium comprising a set of instructions which, when executed by a computing system, cause the computing system to:
perform, under direction of an operating system (OS), a boot procedure by loading and executing one or more basic input output system (BIOS) boot modules;
load and execute, under direction of the OS, one of the one or more BIOS boot modules during runtime using a changed hardware configuration parameter; and
load and execute, under direction of the OS, a new or updated BIOS boot module during runtime;
wherein the OS is to execute on the computing system.

46. The at least one computer readable storage medium of claim 45, wherein the instructions, when executed by a computing system, further cause the computing system to establish a secure BIOS environment for execution of the one or more BIOS boot modules and execution of the new or updated BIOS boot module.

47. The at least one computer readable storage medium of claim 46, wherein to establish the secure BIOS environment, the instructions, when executed by the computing system, cause the computing system to:
authenticate each of the one or more BIOS boot modules and the new or updated BIOS boot module prior to execution; and
at least one of limit access rights to a hardware configuration register or limit access rights to a memory from which each of the one or more BIOS boot modules and the new or updated BIOS boot module is to be executed.

48. The at least one computer readable storage medium of claim 47, wherein the secure BIOS environment is provided at least in part by an extended instruction set or an operating mode of the processor to support boot module authentication, limited hardware register access rights, or limited memory access rights.

49. The at least one computer readable storage medium of claim 45, wherein the changed hardware configuration parameter includes one of a parameter to set a hardware port, a memory or drive partition, a CPU power package limit or flexible ratio, a persistent memory configuration, or a platform controller hub (PCH) configuration for clock gating, serial peripheral interface (SPI), power management controller (PMC), and/or direct media interface (DMI), and
wherein the new or updated bios boot module is to at least one of improve system security, improve system functionality, and/or provide compatibility with a new or updated hardware device or software package.

50. The at least one computer readable storage medium of claim 45, wherein the one or more BIOS boot modules are to be retrieved from memory other than startup BIOS memory prior to execution.
